(19) United States
(12) Patent Application Publication
(10) Pub. No.: US 2019/0070541 A1
(43) Pub. Date: Mar. 7, 2019

(54) FILTER MATERIAL AND FILTRATION ASSEMBLY

(71) Applicant: Pure Flow Filtersysteme GmbH, Muenchberg (DE)

(72) Inventor: Ludwig Kuenzel, Regnitzlosau (DE)

(21) Appl. No.: 16/182,770

(22) Filed: Nov. 7, 2018

Related U.S. Application Data
(63) Continuation of application No. PCT/IB2017/052294, filed on Apr. 21, 2017.

(30) Foreign Application Priority Data
May 10, 2016 (DE) 102016108558.8
May 10, 2016 (DE) 202016105559.8

(51) Int. Cl. B01D 39/16; B01D 39/18; B01D 39/04

(52) U.S. Cl. CPC B01D 39/163; B01D 39/18; B01D 39/04; B01D 2239/0618; B01D 2239/0668; B01D 2239/1233; B01D 2239/1291; B01D 2239/0407

(57) ABSTRACT

A filter material for liquid media comprising plural individual layers of non-woven fabric and its use in a filtration assembly are disclosed. Each layer of non-woven fabric comprises a plurality of filaments, which to a defined degree are connected to other filaments via material bonds. Likewise neighboring layers of non-woven fabric are connected to a certain degree with neighboring layers of non-woven fabric and thus form a compound layer of non-woven fabric with a defined top side and a defined bottom side. The filter material of the compound layer of non-woven fabric is cut into geometric filter bodies having the top side and the bottom side of the compound layer of non-woven fabric.

### CROSS-REFERENCE TO RELATED APPLICATIONS

This application is a Continuation of International Patent Application Serial No. PCT/IB2017/052294, filed on Apr. 21, 2017, which application claim priority from German Patent Application No. DE 20 2016 105 559.8, filed on May 10, 2016, and German Patent Application No. DE 10 2016 108 558.8, filed on May 10, 2016, which applications are incorporated herein by reference in their entireties.

### FIELD OF THE INVENTION

The invention broadly relates to a filter material for liquid media and to a filtration assembly for liquid media.

### BACKGROUND OF THE INVENTION

The invention relates to a filter material for liquid media comprising plural individual layers of non-woven fabric, wherein each layer of non-woven fabric comprises a plurality of filaments. The filaments are connected to other filaments via material bonds. Likewise, filaments of a layer of non-woven fabric extend into neighboring layers of non-woven fabric, and in the neighboring layers of non-woven fabric partially or to a certain degree are connected to the filaments of the neighboring layers of non-woven fabric via material bonds. By the plurality of layers of non-woven fabric a compound layer of non-woven fabric is formed, having a top side and a bottom side.

Furthermore, the invention relates to a filtration assembly for liquid media. The filtration assembly comprises a filter housing with an inlet for the medium to be filtered and an outlet for the filtered medium.

German Patent Application DE 100 44 218 A1 discloses the use of polyisocyanide resins in filter layers. Wet strength filters, in particular depth filters, of high swelling ability are disclosed. The filters comprise a filter matrix of cellulose fibers. The cellulose fibers have chemically bound polyisocyanide at their surface. The filter matrix also comprises synthetic materials. The strength of the open filter layers, according to experience, is improved by the use of long fibers. The cellulose filter for the largest part is made of long fibers and with these forms a non-woven fabric of fibers.

German utility model DE 201 06 073 U1 discloses a mechanical filter cartridge for a liquid filter, in particular a water filter, for swimming pools, swimming baths, ponds and the like. The water filter is arranged in a pre-defined current path. The filter cartridge has long fiber plastic bristles which extend into the current path and preferentially cover it completely.

The German patent DE 10 2007 027 299 B4 discloses a filter of a multilayer filter medium with at least one support layer of non-woven fabric of synthetic polymer fibers. At least one filter layer is provided on at least one side of the non-woven support fabric, and at least one cover layer is provided on the side of the filter layer facing away from the support layer. The non-woven fabric is made of filaments, i.e., fibers of infinite length, or of staple fibers. The non-woven fabrics, which preferentially are wet-laid, spun-laid or dry-laid non-woven fabrics, are strengthened by thermal and/or chemical bonding and/or mechanical strengthening.

German patent application DE 3 623 786 A1 discloses a method for manufacturing soot filters. For the soot filters, porous fiber mats are produced from spooled or loose fibers joined to a felt- or cotton-like aggregate. The fibers are brought in contact with a bonding substance, wherein the fibers of the fiber mat are coated with the substance, so that the fibers are connected to each other by the coating substance almost exclusively in the crossing regions.

German patent application DE 40 15 505 A1 discloses a geotextile filter material. This filter material is used in the geotechnical sector and has to be permeable by liquid. A non-woven fabric is produced from synthetic filaments and/or staple fibers. Furthermore, the non-woven fabric may be connected to a further textile material.

German patent application DE 102 27 246 A1 relates to an aerodynamically formed composition and a non-woven fabric for filters (air filters, liquid filters), etc. The bonding of the non-woven fabric may be done aerodynamically, by simply mixing the various fibers together and exposing them to an air current, which mixes the fibers together into an area. Subsequently further steps follow, like heating, partial melting, etc.

European patent application EP 25 10 992 A1 discloses a filter material for purifying a fluid. The filter material includes a non-woven fabric of fibers, formed by a plurality of synthetic fibers. The filter material has relatively coarse fibers and has special surface properties as well as a low density. The bonding between the individual fibers of the non-woven fabric of fibers is improved by a mechanical treatment of the fibers. The mechanical treatment creates notches in the fibers.

U.S. Pat. No. 4,910,064 discloses a textile-like, non-woven, but spun continuous web from a plurality of filaments of thermoplastic polymers. This web is an individual, single, layer of non-woven material, but not a filter. The filaments are connected to other filaments via material bonds to a defined degree.

European patent application EP 1 277 865 A1 discloses a filter material (compound of non-woven fabrics) for liquid media. The filter material comprises a single geometric filter body, i.e., the welded compound of non-woven fabrics with wave-like structures or corrugations, respectively, and an inner shrunk extended fiber aggregate. The filter material is formed by plural individual layers of non-woven fabric. The inner shrunk extended fiber aggregate may be a non-woven fabric and comprise a plurality of filaments, which are connected to other filaments via material bonds to a defined degree. The individual layers are laminated and thus form a compound layer of non-woven fabric with a top side and a bottom side.

Prior art filter materials based on polymers, and the use of such filter materials in filtration assemblies cover fewer use cases than the filter material according to the invention in connection with the filtration assembly according to the invention. Furthermore, the prior art filter material, contrary to the filter material of the present invention, is not chemically resistant. Furthermore, with prior art polymer filter materials, a flocculant is necessary in order to achieve the desired filter effect. In addition, the selectivity of prior art filter materials is not as small as for the filter material according to the invention. Furthermore, with the prior art filter material, there is the risk of clumping or scaling.

Thus, there has been a long-felt need for a filter material for liquid media which enables the filtration of liquid media at low cost and reduced effort, and which treats the liquid medium to be filtered with high efficiency.

### BRIEF SUMMARY OF THE INVENTION

It is a general object of the invention to provide a filter material for liquid media which enables the filtration of liquid media at low cost and reduced effort, and which treats the liquid medium to be filtered with high efficiency.

This object is achieved by a filter material for liquid media comprising one or more geometric filter bodies, wherein the filter material is formed by plural individual layers of non-woven fabric, wherein each layer of non-woven fabric comprises a plurality of filaments, which are to a certain degree connected to other filaments via material bonds and wherein filaments of a layer of non-woven fabric extend into neighboring layers of non-woven fabric and also are connected to a certain degree with the filaments of the neighboring layers of non-woven fabric and form a compound layer of non-woven fabric with a top side and a bottom side, wherein the geometric filter bodies are cut from and separated from the compound layer of non-woven fabric and have the top side and the bottom side of the compound layer of non-woven fabric.

It is another object of the invention to provide a filtration assembly for liquid media which performs the filtering of the liquid medium at low cost and with low time requirements. Also, the filtering of the liquid medium is to be performed reliably and the service costs for the filter assembly are to be considerably reduced.

This object is achieved by a filtration assembly for liquid media comprising a filter housing with an inlet for the medium to be filtered; and, an outlet for the filtered medium, characterized in that at least one filter layer of at least one geometric filter body cut from a compound layer of non-woven fabric of a filter material one or more geometric filter bodies, wherein the filter material is formed by plural individual layers of non-woven fabric, wherein each layer of non-woven fabric comprises a plurality of filaments, which are to a certain degree connected to other filaments via material bonds and wherein filaments of a layer of non-woven fabric extend into neighboring layers of non-woven fabric and also are connected to a certain degree with the filaments of the neighboring layers of non-woven fabric and form a compound layer of non-woven fabric with a top side and a bottom side, wherein the geometric filter bodies are cut from and separated from the compound layer of non-woven fabric and have the top side and the bottom side of the compound layer of non-woven fabric is provided in the filter housing, wherein the inlet for the medium to be filtered is directed to the at least one filter layer, and the outlet for the filtered medium is downstream from the at least one filter layer.

These and other objects and advantages of the present invention will be readily appreciable from the description of preferred embodiments of the invention, from the accompanying drawings and claims which follow this summary description.

The filter material for liquid media according to the invention is characterized in that plural individual layers of non-woven material have been placed on top of each other, wherein each layer of non-woven material comprises a plurality of filaments. The filaments are connected to each other via material bonds within a layer of non-woven fabric and also with neighboring layers of non-woven fabric to a certain degree, respectively. To this end the filaments of neighboring layers of non-woven fabric extend from layer of non-woven fabric into layer of non-woven fabric, in order to in this way establish the material bond also between the individual neighboring layers of non-woven fabric. A compound layer of non-woven fabrics is formed by the connection of the individual neighboring layers of non-woven fabric, with a top side and a bottom side. The filter material according to the invention comprises geometric filter bodies which are cut from the compound layer of non-woven fabric, wherein these cut filter bodies have the top side and the bottom side of the compound layer of non-woven fabric.

By connecting the filaments within a layer of non-woven fabric with each other or by connecting the filaments with the filaments of neighboring layers of non-woven fabric, the mechanical properties within a layer of non-woven fabric and between the layers of non-woven fabric can be set via the number of connections between the filaments per unit volume. The expression “number of connections” may be understood as “to a certain extent” or “to a certain degree”.

The cut geometric filter bodies are elastically reversible. Also, the cut geometric filter bodies are of stable shape. The filaments from which the individual layers of non-woven fabric are made are polyester fibers. According to a possible embodiment of the invention the filaments of the compound layer of non-woven fabric may include activated carbon. Thus the filter body as a whole includes activated carbon.

Since the filter bodies are of stable shape and reversibly elastic, the filter bodies can be stored in a container which is evacuated and deformed. Thereby the filter bodies are compressed, so that the costs of storage and the transport volume are significantly reduced. Prior to use of the filter bodies in a filtration assembly a pressure equilibration of the container with the environment is done. As a result thereof, the filter bodies once again assume their original shape and size, which they had at the time of cutting the geometric filter bodies from the compound layer of non-woven fabric.

One possible embodiment of a container with which the geometric filter bodies can be transported and/or stored comprises a deformable material in which an extraction opening is provided. The container can be closed with a closure. As a further possibility for packaging the filter materials it may be conceived that the bag does not have an extraction opening, but is only pressed. During packaging the bag is pressed to a minimum, and a gas- or vacuum-tight closure is provided at the end, by which the pressed or compressed state of the bag is maintained. There is also the possibility to pack the filter material in a pressed state into cardboard.

Filaments of polyester are preferred. The filter material comprises 60/o to 90%/o solid or hollow fibers and 40% to 10% melt fibers. The cross-sectional shape of the filaments is round or oval. The filaments of the filter material have a fiber thickness of about 30 μm to 50 μm. Preferentially, the filaments have a fiber thickness of about 40 μm. The filter material has an area density of 250-1800 grams/square meter.

Furthermore, the invention relates to a filtration assembly for liquid media having a filter housing with an inlet for the medium to be filtered and an outlet for the filtered medium. For filtering the liquid medium at least one filter layer is provided in the filter housing which comprises at least one compound layer of non-woven fabric of a geometric body cut from the filter material. The geometric filter body therein has a top side and a bottom side, corresponding to those of the compound layer of non-woven fabric. The inlet of the filtration assembly for the medium to be filtered is directed to the at least one filter layer. The outlet for the filtered medium is arranged downstream from the at least one filter layer in the filtration assembly.

According to a possible embodiment the at least one filter layer is a single filter body. The shape of the filter body therein is adapted to the inner shape of the filter housing, which is achieved by suitable cutting from the compound layer of non-woven fabric. The single filter body therein has the top side and the bottom side of the compound layer of non-woven fabric.

According to a further embodiment of the invention the filter layer in the filtration assembly may comprise a plurality of individual geometric filer bodies. Each of the filter bodies is cut from the compound layer of non-woven fabric and has a cubic shape. The cubic shape has the top side and the bottom side of the compound layer of non-woven fabric.

According to a further embodiment the filtration assembly may have plural filter layers, wherein at least one comprises a compound layer of non-woven fabric of a filter body cut from a filter material. Likewise an embodiment may be conceived of in which in the filter housing at least one filter layer comprises individual cubic filter bodies and at least one filter layer is a single filter body.

According to a further embodiment of the invention, in the filter housing at least one filter layer may comprise individual cubic filter bodies or at least one filter layer may be a single filter body, wherein activated carbon is bound to at least one layer of non-woven fabric of the compound layer of non-woven fabric. With the filter material according to the invention simple installation and an efficient performance of the filtration are realized. With water or liquid medium, respectively, introduced into the filter housing, the individual segments of the geometric bodies of the filter material become denser. By the increase of density a continuous filter mass results. In the filter mass particles of dirt and even finest suspended matter is caught. The water passes the filter material almost without resistance and is, for example, reintroduced into the pool excellently purified.

Likewise a backflush is possible with the filter material according to the invention or the geometric filter bodies, respectively, in connection with the filtration assembly. This means that the liquid medium, or water, respectively, is reintroduced into the filter housing with the direction of flow reversed. By the reversed current of the liquid medium the individual segments of the geometric bodies separate and release some of the dirt particles, which then can be washed out of the filtration assembly. The filter material may be back-flushed contingently, so that only some of the dirt particles are washed out of the filtration assembly or filter material, respectively. This means that large dirt particles at the top side of the geometric body or of the filter material, respectively, are separated from the filter material by the reversed current of the liquid medium. The smaller dirt particles in the interior of the bodies or of the filter material, respectively, remain stuck there. The filtration assembly is a depth filter and the particles remain stuck in the interior.

With the filter material according to the invention or the filtration assembly according to the invention advantages with respect to the costs for filtration result. For example, energy may be saved, as the filter material provides a high flow rate, so that the pumps may be dimensioned smaller. Due to the high deposition rate, flocculants are largely obsolete. Furthermore, the filter material has a high capacity for dirt absorption and a long lifetime. Also, the filtration assembly according to the invention results in reduced costs for repair and maintenance, documentation, filter locations, filter cartridge, shutter, seals, etc. Likewise, no costs for transport and disposal are incurred. Furthermore, fewer back-flushes are necessary, so that the loss of water and the energy for reheating the supplied fresh water are reduced.

Delivery and storage of the geometric filter elements require little space. Also, the change of filter material in the filter housing can be done easily and quickly, because the filter material is of very low weight. Due to the low resistance of the filter material the liquid medium to be filtered, in a given amount of time, is filtered faster and more often than is the case for prior art filter materials.

Further advantages and advantageous embodiments of the invention are the subject of the subsequent figures and their description.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic sectional view of a compound layer of non-woven fabric, according to an embodiment of the invention;

FIG. 2 is a schematic view of an embodiment of a geometric body which has been cut from a compound layer of non-woven fabric;

FIG. 3 is a sectional view of a possible embodiment of a filtration assembly, in which the filter housing is completely filled with individual geometric filter bodies;

FIG. 4 is a situation in which the filter housing shown in FIG. 3 is in filter mode of the liquid medium;

FIG. 5 is an enlarged view of the filter material with the deposition of dirt particles;

FIG. 6 is a schematic view of the filter housing, where the backflush process has just started;

FIG. 7 is a schematic view of the filter housing, where the backflush process is almost finished;

FIG. 8 is a partial view of a cut open filter housing containing two geometric filter bodies adapted to the shape of the filter housing;

FIG. 9 is a schematic view of a possible embodiment of the configuration of the different filter layers in the interior of a filter housing;

FIG. 10 is a schematic view of a container filled with a plurality of geometric bodies of the filter material; and,

FIG. 11 is a schematic view with the container evacuated.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodologies, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Although any methods, devices or materials similar or equivalent to those described herein can be used in the practice or testing of the invention, the preferred methods, devices, and materials are now described.

It is evident to the skilled person that the embodiments of the compound layer of non-woven fabric and of the bodies cut from the compound layer of non-woven fabric, presented in the description, are not a limitation of the invention. Also a plurality of filter layers may be used for the configuration of the filtration assembly, which may be of different configurations. For example, only filter layers may be provided which comprise individual geometric filter bodies. The combination of the filter layers and their configuration are largely determined by the filtration problem at hand.

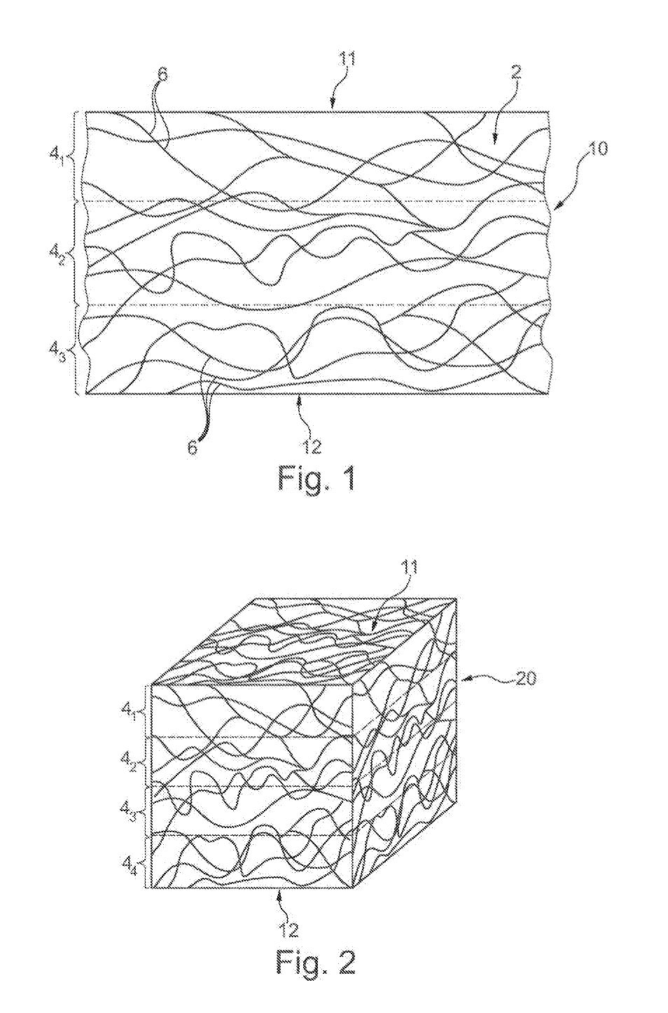

FIG. 1 shows a schematic view of a compound layer of non-woven fabric 10. The compound layer of non-woven fabric 10 in the illustration shown here comprises three individual layers of non-woven fabric 4₁, 4₂, and 4₃. It is evident to the skilled person that the illustration of the compound layer of non-woven fabric 10 shown here is not to be taken as a limitation of the invention. The compound layer of non-woven fabric 10 can, depending on the required mechanical properties, be configured to comprise an arbitrary number of layers of non-woven fabric 4₁, 4₂, . . . 4_{N}. The individual layers of non-woven fabric 4₁, 4₂, . . . , 4_{N} comprise a plurality of filaments 6 which also extend to neighboring layers of non-woven fabric 4₁, 4₂, . . . , 4_{N}. The filaments 6 in the individual layers of non-woven fabric 4₁, 4₂, . . . , 4_{N} and the filaments 6 extending to neighboring layers of non-woven fabric to a certain degree (number of connections of the filaments 6 per unit volume) are connected to each other via material bonds.

The compound layer of non-woven fabric 10 has a top side 11 and a bottom side 12.

For the filtration of liquid media individual geometric filter bodies 20 are cut from the compound layer of non-woven fabric 10 (see FIG. 2). Corresponding to the configuration of the compound layer of non-woven fabric 10 with the individual layers of non-woven fabric 4₁, 4₂, . . . , 4_{N} also the geometric filter body 20 has the corresponding number of layers of non-woven fabric 4₁, 4₂, . . . , 4_{N}. Likewise the geometric filter body 20 has the top side 11 and bottom side 12 of the compound layer of non-woven fabric 10 from which it has been produced or cut, respectively. A particular advantage of the filter material according to the invention and of the filter bodies 20 cut therefrom is the stability of the shape of the filter bodies 20. We remark that the shown geometric shape of the filter body 20 is not to be taken as a limitation of the invention. Filter bodies 20 of any shape and size may be cut from the compound layer of non-woven fabric 10. The only condition is that the cut filter bodies 20 must also have the top side 11 and bottom side 12 of the compound layer of non-woven fabric 10.

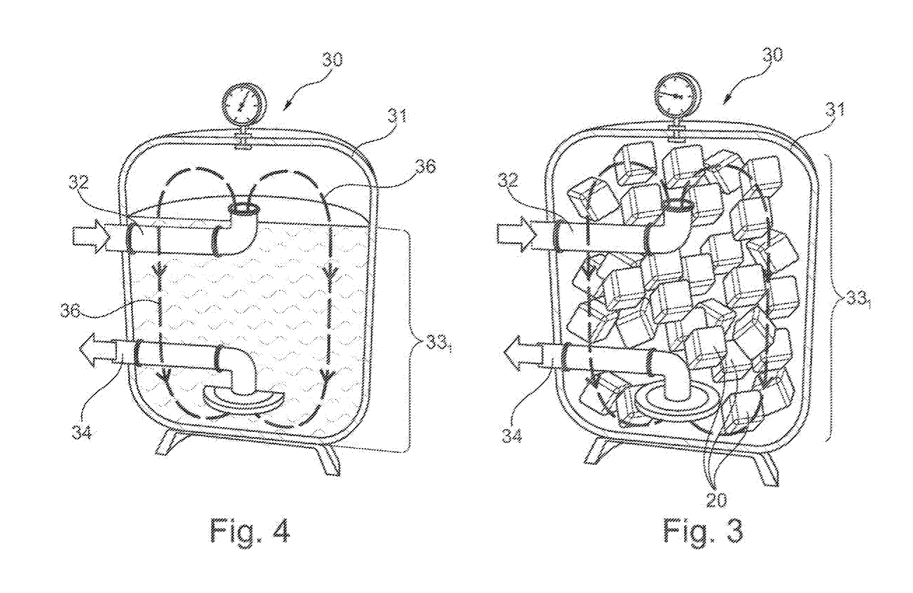

FIG. 3 is a sectional view of a filtration assembly 30 which is completely closed. In the filter housing 31 of the filtration assembly 30, in the embodiment shown here, only one filter layer 33₁ is provided for filtering the liquid medium. The filter layer 33₁ therein comprises a plurality of geometric filter bodies 20 of cubic shape. The liquid medium to be filtered is introduced into the filter housing 31 via an inlet 32. The filtered liquid medium exits the filter housing 31 via an outlet 34.

In the illustration of FIG. 4 so much liquid medium to be filtered has been introduced via inlet 32 that the individual filter bodies 20 have been compressed to a single, essentially homogeneous filter mass. The filter layer 33₁ resulting therefrom is passed by the medium to be filtered along trajectories 36. The filtered liquid medium, as has already been mentioned with respect to FIG. 3, exits via outlet 34, and may be provided for a further use (e.g., swimming pool).

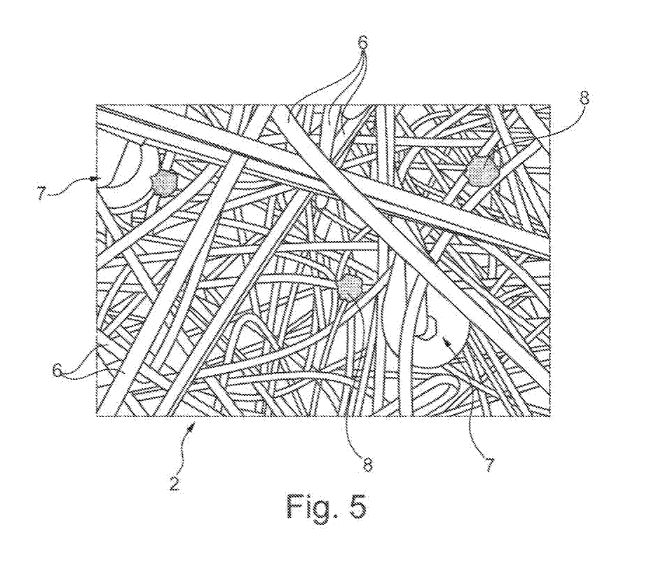

FIG. 5 shows an enlarged view of the filter material 2, in which the individual filaments 6 can be seen in their disordered arrangement in the filter material 2. The liquid medium 7 passes between the filaments 6. Therein particles 8 are unloaded and get stuck to the filaments 6. By this effect the purification of the liquid medium 7 occurs.

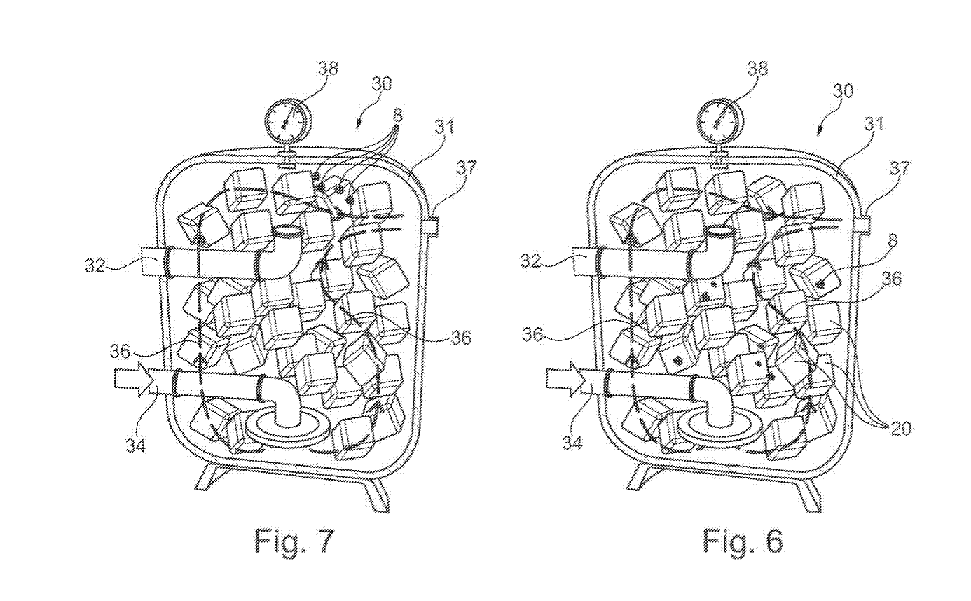

FIGS. 6 and 7 show the situation of a backflush process, in which particles 8 in the individual geometric filter bodies 20 can be washed out. In the illustration of FIG. 6 the backflush process is just starting. Clean liquid medium is introduced via outlet 34. Thereby the individual geometric filter bodies 20 loosen up and separate and essentially fill the entire interior of the filter housing 31. The liquid medium introduced via outlet 34 moves along trajectories 36 to a drain 37. In the illustration shown in FIG. 7 the particles 8 have already been carried into the region of the drain 37 by the flow of liquid in the filter housing 31, or have already been washed out through the drain 37. The manometer 38 connected to the filter housing 31 is provided to monitor the pressure within the filter housing 31. The filter housing 31 of the embodiments shown in FIGS. 3 and 4 and 6 and 7 is a filter housing 31 operating at excess pressure.

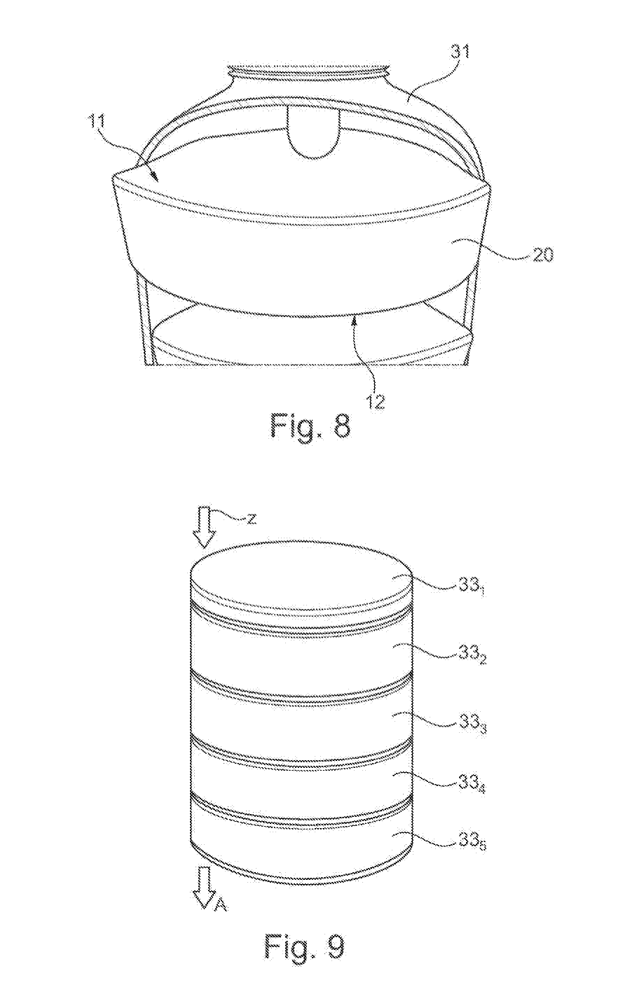

FIG. 8 shows a partial view of a cut open filter housing 31 wherein the geometric filter body 20 in the filter housing 31 is adapted to the interior shape of the filter housing 31. In the embodiment shown the geometric filter body 20 has been cut from the compound layer of non-woven fabric 10 in such a way that it is adapted to the inner shape of the filter housing 31. As already described in the preceding discussion, the geometric filter body 20 also has the top side 11 and the bottom side 12 of the compound layer of non-woven fabric 10.

FIG. 9 shows a possible embodiment of the configuration of various filter layers 33₁, 33₂, . . . , 33_{K}, responsible for filtering the liquid medium in a filtration assembly (not shown). The liquid medium is applied onto the top filter layer 33₁ in feed direction Z. The release A of the filtered liquid medium occurs through the bottom filter layer 33₅. It is evident that the five filter layers 33₁, 33₂, 33₃, 33₄, and 33₅ described here cannot be taken as a limitation of the invention. Arbitrary combinations of filter layers 33₁, 33₂, . . . , 33_{K} may be used for the filtration of a liquid medium, of course. The combination of the individual filter layers 33₁, 33₂, . . . , 33₅ may be adapted to the respective filtration requirements. The medium to be filtered is applied onto the top filter layer 33₁. The top filter layer 33₁ may for example be a filter mesh. The filter mesh may be of plastic or stainless steel. The top filter layer 33₁ is followed by a further filter layer 33₂ comprising plural individual cubic filter bodies 20. In the next filter layer 33₃ for example an entire disc or a filter body 20, respectively, adapted to the interior of a filter housing (not shown) may be provided. In the next filter layer 33₄ a further filter body 20 adapted to the interior of the filter housing 31 may be provided. In this filter body 20 at least one layer of non-woven fabric (not shown) includes activated carbon. The bottom filter layer 33₅ may again be a filter mesh, of higher density than the filter mesh of the top filter layer 33₁. The filter mesh of the bottom filter layer 33₅ may be of plastic or stainless steel.

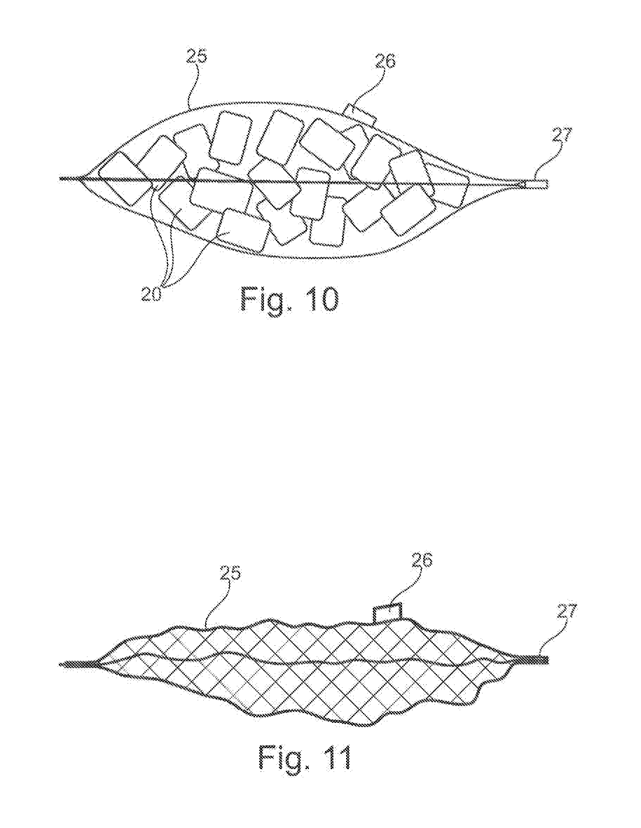

FIG. 10 shows a possible embodiment of a container 25, with which the geometric filter bodies 20 can be transported and/or stored. The container 25 comprises a deformable material, with an extraction opening 26. The container 25 can be closed with a closure 27. Further possible embodiments of the packaging of the filter bodies 20 have been mentioned in the introductory part of the description.

FIG. 11 shows a situation in which air has been withdrawn from the container 25 via extraction opening 26. Thereby the bodies 20 in the interior of the container 25 are compressed, and a deformed container results, which has a significantly smaller volume than the container 25 shown in FIG. 10.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE NUMBERS

2 filter material
4₁, 4₂, . . . , 4_{N} layer of non-woven fabric
6 filaments
7 liquid medium
8 particle
10 compound layer of non-woven fabric
11 top side
12 bottom side
50 geometric filter body
25 container
26 extraction opening
27 closure
30 filtration assembly
31 filter housing
32 inlet
33₁, 33₂, . . . , 33_{K} filter layer
34 outlet
36 trajectories
37 drain
38 manometer
A release
Z feed direction

What is claimed is:

1. A filter material for liquid media, the filter material, comprising: one or more geometric filter bodies, wherein the filter material is formed by plural individual layers of non-woven fabric, wherein each layer of non-woven fabric comprises a plurality of filaments, which are to a certain degree connected to other filaments via material bonds and wherein filaments of a layer of non-woven fabric extend into neighboring layers of non-woven fabric and also are connected to a certain degree with the filaments of the neighboring layers of non-woven fabric and form a compound layer of non-woven fabric with a top side and a bottom side, wherein the geometric filter bodies are cut from and separated from the compound layer of non-woven fabric and have the top side and the bottom side of the compound layer of non-woven fabric.

2. The filter material of claim 1 wherein the cut geometric filter bodies are elastically reversible and of stable shape, in such a way that the filter bodies can be stored in a container that can be evacuated and deformed, and that after a pressure equilibration of the container with the environment the filter bodies again assume the shape corresponding to the shape and size of the geometric filter bodies cut from the compound layer of non-woven fabric.

3. The filter material recited in claim 1 wherein the filaments are made of polyester.

4. The filter material recited in claim 2 wherein the filaments are made of polyester.

5. The filter material of claim 3 wherein 60% to 90% of the filaments are solid fibers or hollow fibers, and 40% to 10% of the filaments are melt fibers.

6. The filter material of claim 4 wherein 60% to 90% of the filaments are solid fibers or hollow fibers, and 40% to 10% of the filaments are melt fibers.

7. The filter material of claim 1 wherein the filaments of the filter material have a fiber thickness of about 40 μm.

8. The filter material of claim 2 wherein the filaments of the filter material have a fiber thickness of about 40 μm.

9. The filter material of claim 1, wherein the filaments have a cross-section of a round and oval shape.

10. The filter material of claim 2 wherein the filaments have a cross-section of a round and oval shape.

11. The filter material of claim 1 wherein the filter material has an area density of 250-1800 grams/square meter.

12. The filter material of claim 2 wherein the filter material has an area density of 250-1800 grams/square meter.

13. The filter material of claim 1 wherein the filaments of all layers of non-woven fabric of the compound layer of non-woven fabric include activated carbon.

14. The filter material of claim 2 wherein the filaments of all layers of non-woven fabric of the compound layer of non-woven fabric include activated carbon.

15. Filtration assembly for liquid media, comprising
a filter housing with an inlet for the medium to be filtered; and,
an outlet for the filtered medium, characterized in that at least one filter layer of at least one geometric filter body cut from a compound layer of non-woven fabric of a filter material one or more geometric filter bodies, wherein the filter material is formed by plural individual layers of non-woven fabric, wherein each layer of non-woven fabric comprises a plurality of filaments, which are to a certain degree connected to other filaments via material bonds and wherein filaments of a layer of non-woven fabric extend into neighboring layers of non-woven fabric and also are connected to a certain degree with the filaments of the neighboring layers of non-woven fabric and form a compound layer of non-woven fabric with a top side and a bottom side, wherein the geometric filter bodies are cut from and separated from the compound layer of non-woven fabric and have the top side and the bottom side of the compound layer of non-woven fabric is provided in the filter housing, wherein the inlet for the medium to be filtered is directed to the at least one filter layer, and the outlet for the filtered medium is downstream from the at least one filter layer.

16. The filtration assembly of claim 15 wherein the at least one filter layer is a single filter body, the shape of which is adapted to the inner shape of the filter housing by cutting from the compound layer of non-woven fabric, and which has the top side and the bottom side of the compound layer of non-woven fabric.

17. The filtration assembly of claim 16 wherein the at least one filter layer comprises a plurality of individual geometric filter bodies, and each filter body is cut from the compound layer of non-woven fabric, has a cubic shape and the top side and the bottom side of the compound layer of non-woven fabric.

18. The filtration assembly of one of the claim 15 wherein plural filter layers are provided within the filter housing, and at least one of them is a geometric filter body cut from the filter material of a compound layer of non-woven fabric.

19. The filtration assembly of claim 18 wherein in the filter housing at least one filter layer comprises individual cubic filter bodies and at least one filter layer is a single filter body.

20. The filtration assembly of claim 19 wherein in the filter housing at least one filter layer comprising individual cubic filter bodies or at least one filter layer of a single filter body is provided, wherein activated carbon is bound in all layers of non-woven fabric of the compound layer of non-woven fabric.

21. The filtration assembly of claim 15 wherein the at least one filter layer in the filter housing is respectively arranged between at least one layer of fabric.
